(19) United States
(12) Patent Application Publication
(10) Pub. No.: US 2005/0075080 A1
(43) Pub. Date: Apr. 7, 2005

(54) Inter-chip and intra-chip wireless communications systems

(75) Inventor: Yue Ping Zhang, Singapore (SG)

Correspondence Address: STEPHEN B. ACKERMAN, 28 DAVIS AVENUE, POUGHKEEPSIE, NY, 12603, US

(73) Assignee: Nanyang Technological University

(21) Appl. No.: 10/958,071

(22) Filed: Oct. 4, 2004

Related U.S. Application Data
(60) Provisional application No. 60/508,394, filed on Oct. 3, 2003.

(51) Int. Cl. H04B 1/38

(52) U.S. Cl. 455/73

(57) ABSTRACT

A method and implementation for communicating between logic functions using non-metallic coupling between logic functions on a same chip or separate chip is shown. For communication on the same chip, radiated energy from an antenna coupled to a transmitting logic function is coupled to a receiving antenna and then coupled by an electrical connection to a receiving logic function. Communication between USLI chips mounted on a module is performed by coupling an RF signal from a first chip to a μ-satellite mounted within the module and then coupling the RF signal from the satellite to a second chip. Communication can also be formed between the satellite and different logical functions on the same USLI chip.

This application claims priority to Provisional Patent Application Ser. No. 60/508,394, filed on Oct. 3, 2003, which is herein incorporated by reference in its entirety.

### BACKGROUND OF THE INVENTION

1. Field of Invention

The present invention is related to communication between integrated circuits and in particular inter-chip and intra-chip wireless communications.

2. Description of Related Art

The advancement in the development of semiconductor devices continues with an improvement in circuit density and performance. To accomplish this there is a reduction in CMOS device size including the width and spacing of the interconnecting metallization. Operating speed and cut-off frequencies of the CMOS devices are increasing and speeds greater than 100 GHz will be realized in the future. The resistance of interconnecting wiring is being maintained by the use of copper wiring, but the total length of wiring is increasing as complete functions are integrated into the semiconductor chips and capacitance per unit length is increasing. Contact and via resistance is increasing because of the size reduction, and the resistance is becoming a bigger part of the total wire net resistance where Rnet=Rwire+Rcontact+Rvia. As the wiring resistance increases, the interconnecting wiring is becoming RC transmission lines where the RC delay constant τ=Rwire×Cwire. The capacitance between metal lines is also increasing as a result of closer line spacing. Thus the voltage drop across the wire is increasing as well as the delay of signals from the driving circuit to the receiving circuit.

In B. A. Floyd, C. M. Hung, and K. O. Kenneth, “Intra-chip wireless interconnect for clock distribution implemented with integrated antennas, receivers, and transmitters,” IEEE Journal of Solid State Circuits, May 2002, Vol. 37, No. 5, pp. 534-552, a wireless interconnect system is directed to the use of radio frequency (RF) to communicate across a semiconductor integrated circuit chip with transmitters and receivers with integrated receivers. Y. P. Zhang, “Bit-error-rate performance of intra-chip wireless interconnect system”, IEEE Communication Letters, January 2004, Vol. 8, No.1 , pp 39-41, is directed to evaluation of bit-error-rate performance of a coherent phase shift interconnect system operating on intra-chip wireless channel at 15 GHz. Kihong Kim and Kenneth K. O, “Characteristics of integrated dipole antennas on bulk, SOI, and SOS substrates for wireless communications”, IEEE IITC, 1998, pp 21-23, is directed to integrated antennas on bulk, SOI and SOS substrates.

A. B. M. H. Rashid, S Watanabe and T. Kikkawa, “High transmission gain integrated antenna on extremely high resistivity Si for ULSI wireless interconnect”, IEEE Electron Device Letters, Vol. 23, No.12, December 2002, pp 732-733, is directed to a high transmission gain integrated dipole antenna on silicon. K. T. Chan, Albert Chin, Y. B. Chen, Y. D. Lin, T. S. Duh and W. J. Lin, “Integrated antennas on Si, proton-implanted Si, and silicon-on-quartz”, IEEE IEDM Technical Digest, 2001, pp903-906, is directed to a high performance antenna on a proton-implanted silicon with 10⁶ ohm-centimeter resistivity. P. M. Mendes, S. Sinaga, A. Polyakov, M. Bartek, J. N. Burghartz, J. H. Correia, “Wafer-level integration of on-chip antennas and RF passives using high-resistivity polysilicon substrate technology,” Electronic Components and Technology Conference 2004, pp. 1879-1884, is directed to high-resistivity wafers that are utilized as low loss substrates for three-dimensional integration of on-chip antennas and RF passive components.

M. Zheng, Q. Chen, P. S. Hall, V. F. Fusco, “Broadband micro-strip patch antenna on micro-machined silicon substrates,” Electronics Letters, vol. 34, no. 1, pp. 3-4, January 1998, is directed to micro-machined micro-strip patch antenna developed on high resistivity silicon wafers. C. R. Trent, T. M. Weller, “Design and tolerance analysis of a 21 GHz CPW-fed, slot-coupled, micro-strip antenna on etched silicon,” IEEE AP-S Digest, 2002 Vol. 1, pp. 402-405, is directed to a rectangular patch antenna on high resistivity silicon. Mau-Chung Frank Chang et al, “RF/wireless interconnect for inter- and intra-Chip communications,” Proceedings of the IEEE, vol. 89, no. 4, April 2001, pp 456-463, is directed to an RF wireless interconnect concept for future inter- and intra-ULSI communications. Robert H. Havemann, James A. Hutchby, “High performance interconnects: An integration overview,” Proceedings of the IEEE, vol. 89, no. 5, May 2001, pp 586-601, is directed to a discussion of high performance interconnections resulting from the scaling of chip wiring not keeping pace with other factors of semiconductor integrated circuits.

High data rate transmission for multimedia applications use wireless networks to provide coverage of nearby applications, for example, wireless local area networks (WLAN) operate at 11 Mbps for 100 m, wireless personal area networks (WPAN) at 100 Mbps for 10 m, and wireless body area networks (WBAN) at 600 Mbps for 1 m. It follows that a μ-CAN (micro-chip area network) network could be useful in providing communications between functions on a large integrated circuit chip as well as communications between functions on separate chips located on a multi-chip module, where distances are measured in less than a few centimeters and data rates are Gbps (gigabits per second).

### SUMMARY OF THE INVENTION

It is an objective of the present invention to provide a radio frequency (RF) communication between functions located on a semiconductor integrated circuit chip.

It is further an objective of the present invention to use RF communications on an integrated circuit chip when the interconnecting wiring has a configuration that produces a dominant limitation to circuit performance.

It is still an objective of the present invention to provide antennas configured by chip metallization to allow RF signal propagation between a sending function and a receiving function.

It is also an objective of the present invention to provide RF communications between functions located on separate integrated circuit chips located on a multi-chip module.

It is still further an objective of the present invention to use antennas coupled to a μ-Satellite to receive RF signals from a sending chip and transfer those signals to a receiving chip.

It is also further an objective of the present invention to provide a μ-Satellite capability to communicate between chips that are wire-bonded and chips that are flip-chip mounted on a module.

In the present invention functions located on a large semiconductor integrated circuit chip communicate with one another through RF (radio frequency) signals. A sending circuit coupled to an antenna transmits an RF signal to a receiving circuit coupled to a similar antenna. The antennas are constructed from chip metallization and have a dipole like structure. The arms of the dipole antenna can have various shapes comprising straight lengths of wire and zigzag, where the zigzag configuration can be in the form a saw tooth or a square wave. The frequencies of the RF signals are in a range where the length of each arm of the dipole antennas is an appreciable portion of a quarter wavelength.

A micro satellite (μ-satellite) placed within a multi-chip package allows integrated circuit chips to communicate through RF signals. An signal is coupled to a first antenna on a first integrated circuit chip, wherefrom an RF signal is transmitted to a second antenna located in the module package a coupled to the μ-satellite. The μ-satellite couples the RF signal to a third antenna located in the module package, which then transmits the RF signal to a fourth antenna on a second integrated circuit chip. The μ-satellite is bidirectional so that communications between the first chip and the second chip can be in either direction.

For packages in which chips are wire bonded, the μ-satellite and its associated antennas are located on the module cap above the integrated circuit chips, whereby each antenna associated with the μ-satellite are located over one of the semiconductor chips mounted on the module. For packages in which chips are flip-chip bonded, the μ-satellite and its associated antennas are located on the bonding surface of the module, whereby each antenna associated with the μ-satellite is located underneath one of the semiconductor chips mounted on the module. A subset of this configuration is RF communications between a single integrated circuit chip to a μ-satellite which retransmits the RF signal back to the single integrated circuit chip.

### BRIEF DESCRIPTION OF THE DRAWINGS

This invention will be described with reference to the accompanying drawings, wherein:

FIG. 1A is a diagram of the present invention of a transmitter circuit and a plurality of receiving circuits on a large integrated circuit chip,

FIG. 1B is a diagram of the present invention of a sample of possible antennas,

FIG. 1C is a block diagram of the present invention of a transmitting circuit,

FIG. 1D is a block diagram of the present invention of a receiving circuit,

FIG. 2A is a diagram of the present invention of an RF radio circuit coupled to a plurality of functions on a large integrated circuit chip,

FIG. 2B is a block diagram of the present invention of an RF radio send and receive circuit,

FIG. 2C is a circuit diagram of the present invention that shows how narrow pulses are created that are coupled to the transmit and receive switch in FIG. 2B,

FIG. 2D is a circuit diagram of the present invention for a differential transmit and receive switch,

FIG. 3A is a block diagram of prior art of a peripheral component interconnect express circuit,

FIG. 3B is a block diagram of the present invention of a wireless peripheral component interconnect express circuit,

FIGS. 4A and 4B are diagrams of the present invention of a single chip module using a μ-satellite to communicate RF signals between functions on the single chip,

FIGS. 5A and 5B are diagrams of the present invention of a multi-chip module using a μ-satellite to communicate RF signals between functions on two chips,

FIG. 6 is a block diagram of the present invention of a μ-satellite,

FIG. 7A is a diagram of the present invention of an antenna integrated on a large integrated circuit chip and used to transmit to and from the μ-satellite,

FIG. 7B is a graph of the present invention of an impedance plot versus frequency for the antenna of FIG. 7A,

FIG. 8 is a flow diagram of the present invention of a method to couple signals between functions on a single chip using an RF transmission, and

FIG. 9 is a flow diagram of the present invention of a method to couple signals between functions on separate chips on a module.

### DETAILED DESCRIPTION OF THE PREFERRED EMBODIMENT

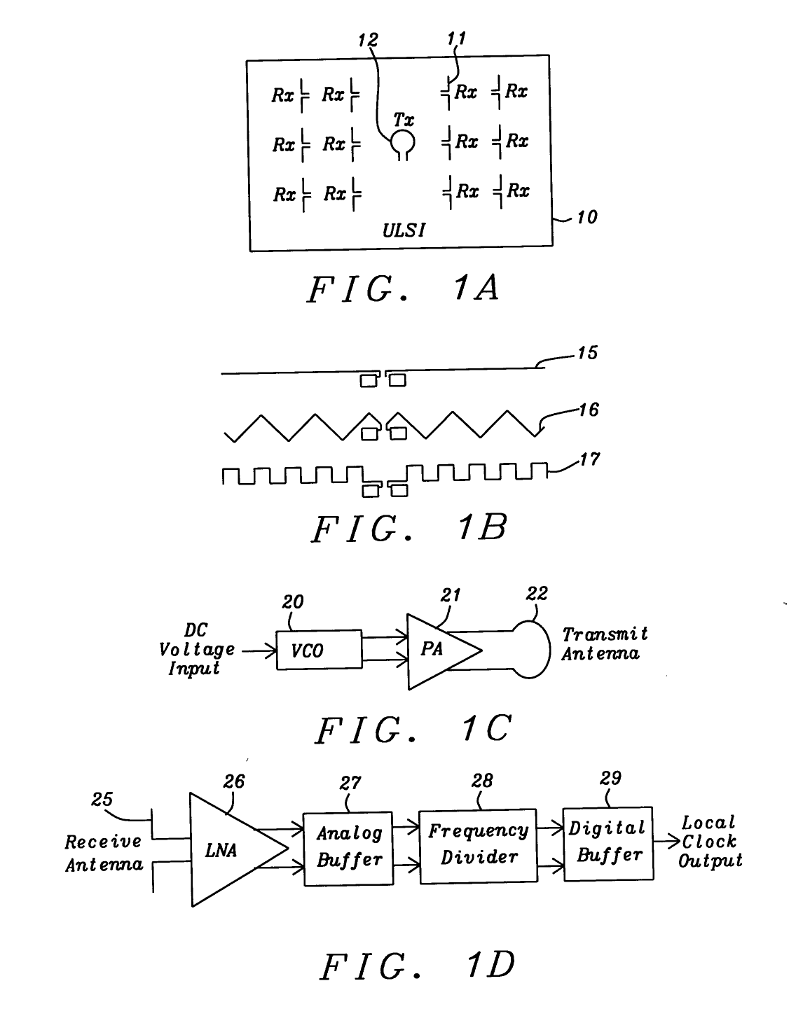

In FIG. 1A is shown a diagram of a large integrated circuit chip 10 with a plurality of receiving circuits 11 and a transmission circuit 12. The plurality of receiving circuits and the transmission circuit are represented by symbols of antennas. In this configuration one sending circuit is communications with a plurality of receiving circuits where the receiving circuits are circuits performing a similar such as is the case with clock signals. FIG. 1 B shows examples of dipole antenna shapes 15, 16 and 17 similar to the shapes that are formed by metallization on the large integrated circuit chip. The length of the antenna is an appreciable amount of a quarter wavelength which requires the frequency of the RF signals that are being transmitted and received to be greater than a gigahertz. The higher the transmitted frequency is, the smaller the wavelength of the propagating RF signal and the shorter the length of the dipole antennas. A preferred frequency of the RF signal is greater than twenty-gigahertz; however a frequency greater than three-gigahertz can produce acceptable results. FIG. 1C shows a block diagram of the transmitting circuit 12 in which a DC voltage is coupled to a voltage-controlled oscillator driving a pulse amplifier 21, which drives the transmitting antenna 22. FIG. 1D shows a diagram of the receiving circuit 11 where a receiving antenna 25 couples the transmitted signal to a low noise amplifier (LNA) 26. The LNA 26 couples the incoming signal to a frequency divider, which couples a signal to a buffer amplifier 29. The buffer amplifier 29 produces a local clock output.

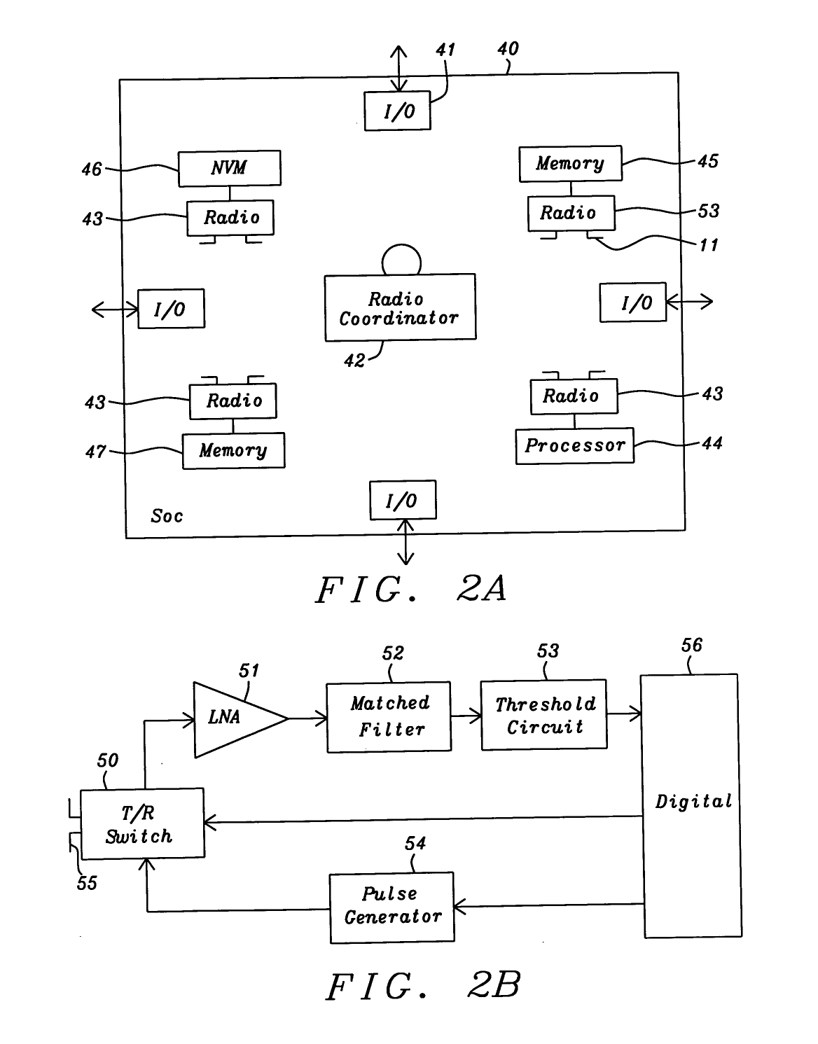

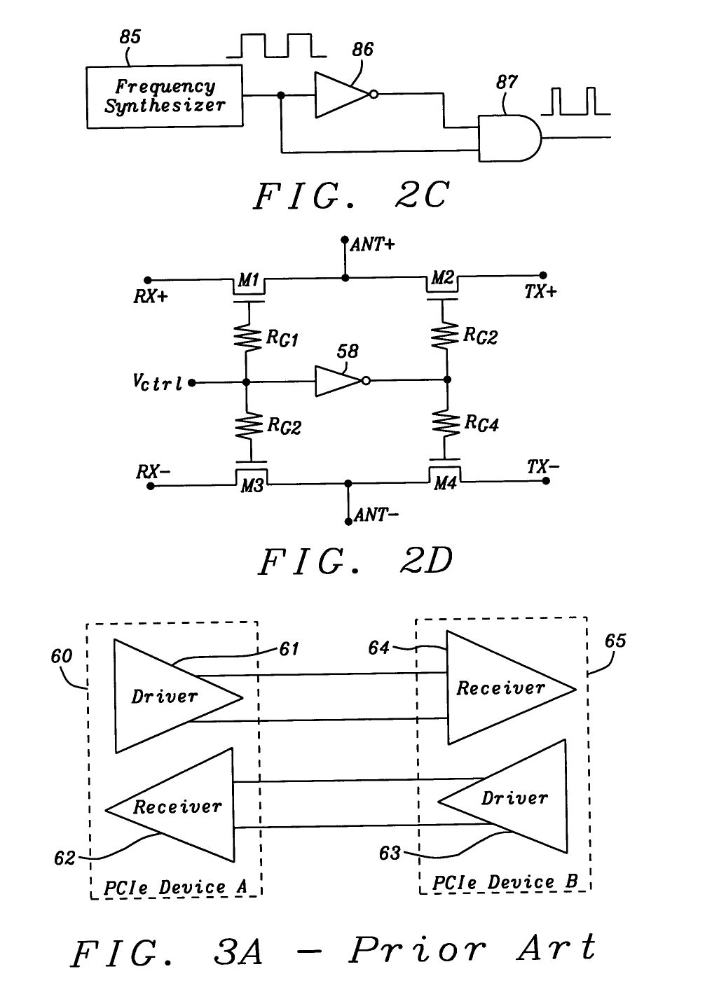

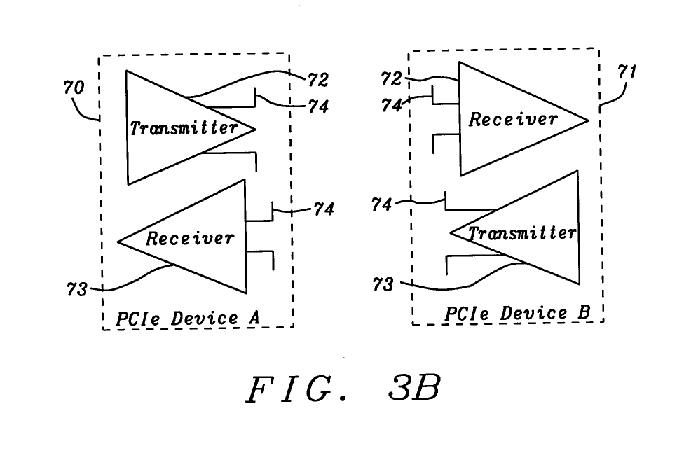

In FIG. 2A is shown a diagram of a large integrated circuit chip 40 containing a system on chip (SoC). The large integrated circuit chip 40 contains external I/O 41, a radio coordinator 42, and a plurality of computing functions 44, 45, 46 and 47, which require communication with other computing functions. Each of the computing functions are coupled to an RF radio 43 that is connected to an antenna 11, which are created with chip wiring and have shapes similar to that shown in FIG. 1B. There are several computing functions that because of the allowed space cannot be next to one another of which those shown in FIG. 2A are an example positioned to demonstrate the present invention. For example, a processor function 44 is connected to an RF radio 43, which requires communication with memory 45 and 47. If there is a non-volatile memory (NVM) 46, then there is a need for the processor 44 to communicate to the NVM for control information or other stored data. Since the plurality of functions in a SoC cannot all be placed next to the functions with which a fast high bandwidth communications is requires, the use of coupling signals by means of RF signals allows the functions to be placed at appropriate layout areas of the chip. The use of RF communication also reduces the load on chip global wiring, which in turn reduces the wiring complexity of the large integrated circuit chip.

Continuing to refer to FIG. 2A, the radio coordinator 42 communicates with all functions 44, 45, 46 and 47 on the chip 40 that are communicating by means of RF transmission. The purpose of the radio coordinator is to perform a multiplexing function such that proper transmission and receiving of the RF signals is carried out in a manner that prevents out of sequence operations. For example, the radio coordinator 42 receives an RF transmission from the processor function 44 and retransmits the RF signal to a logic function, i.e. memory 45 that is physically remote from the processor. The radio coordinator is programmable so that the on-chip RF communication network can be reconfigured to provide priority or block communications to functions that are not operative or have a fault.

In FIG. 2B is shown a block diagram of an ultra wide band (UWB) radio 43. The UWB is carrier free and comprises a transmitter and receiver switch 50, a low noise amplifier 51 coupled to a matched filter 52, that feeds a threshold circuit 53 to deliver a signal a digital logic function 56, and a pulse generator 54 that is coupled between the digital logic function 56 and the transmitter and receiver switch 50. The digital logic function 56 directly drives the transmitter and receiver 50 where the transmitted pulse is directly coupled to the antenna 55 where the radiated power density is less that −41 dBm/MHz and the average transmitted power is less than −2.85 dBm/MHz. Information can be transmitted by pulse amplitude modulation (PAM), and a received pulse is amplified 51, passed through a filter 52 and recovered with the threshold circuit 53.

Continuing to refer to FIG. 2B, the UWB operates over a preferred 7 GHz band from 22 GHz to 29 GHz or a 7.5 GHz band from 3.1 GHz to 10.6 GHZ. The Federal Communication Commission (FCC) allows two bands for the UWB. The higher frequency band allows a shorter antenna, but the design of circuits for the higher frequency band is more difficult. Compared with a conventional radio the UWB is less complex and does not require a reference oscillator, a frequency synthesizer, a voltage controlled oscillator, a mixer, and a power amplifier. The antenna 55 is fabricated on a standard silicon substrate using standard metallization. A transmit and receive switch 50 selects the antenna 55 for transmission of RF signals from a logical function or reception of RF signals from another function. The preferred implementation of the of the receive path 50, 51, 52, and 53 is differential signals to reduce the effect of noise from the large integrated circuit chip.

In FIG. 2C is a circuit diagram of the present invent demonstrating how narrow pulses are formed from the incoming data signal 60. A frequency synthesizer 85, comprising a phase lock loop or a delay-locked loop, is used to stabilize the incoming data signal and remove any jitter in the incoming data. The output of the synthesizer circuit is coupled to an AND circuit 87 along with an output of the inverter circuit 86. The result is a signal from the AND circuit 87 that reduces the data pulses to narrow pulses, which are then coupled to the transmit and receive circuit 50 (FIG. 2B.

FIG. 2D is a circuit diagram of a transmit and receive circuit 50 (FIG. 2B). A control signal Vctrl is coupled to transistor devices M1 and M3 through resistor devices R_{G1} and R_{G3}, and inverter 58. When Vctrl is a high voltage, transistor devices M1 and M3 are turned on coupling the antenna, ANT+and ANT− to the receiver port, RX+ and RX−. When Vctrl is a low voltage, transistor devices M1 and M3 are turned off, and the inverter circuit 58 couples a high voltage to the gates of transistor devices M2 and M4 through resistor devices R_{G2} and R_{G4}, which allows the antenna, ANT+and ANT−, to be coupled to the transmit port TX+ and TX−. The resistor devices, R_{G1}, R_{G2}, R_{G3} and R_{G4} are used to reduce the effect of capacitive coupling to the gates of transistor devices M1, M2, M3 and M4 when the transistor devices are off. The circuit of FIG. 2D is differential allowing for the communication of the high frequency signals of the present invention to reduce semiconductor substrate noise and other common mode noise.

In FIG. 3A is shown a diagram of prior art of a peripheral component interconnect express (PCIe) circuit. The PCIe circuit is a recent industry standard in which a differential driver 61 and a differential receiver 62 reside on PCIe device A 60, and a differential driver 63 and a differential receiver 64 reside on PCIe device B 65. A differential driver 61 on PCIe device A 60 is coupled to differential receiver 64 on PCIe device B 65. Differential receiver 62 on PCIe device A 60 is coupled to differential receiver 64 on PCIe device B 65. The devices shown in FIG. 3A comprise functional units internal or external to a computer that require fast, high bandwidth communications. The PCIe standard is intended to provide architecture that can extends into the future to accommodate the ever-increasing requirements for communication performance between functional units.

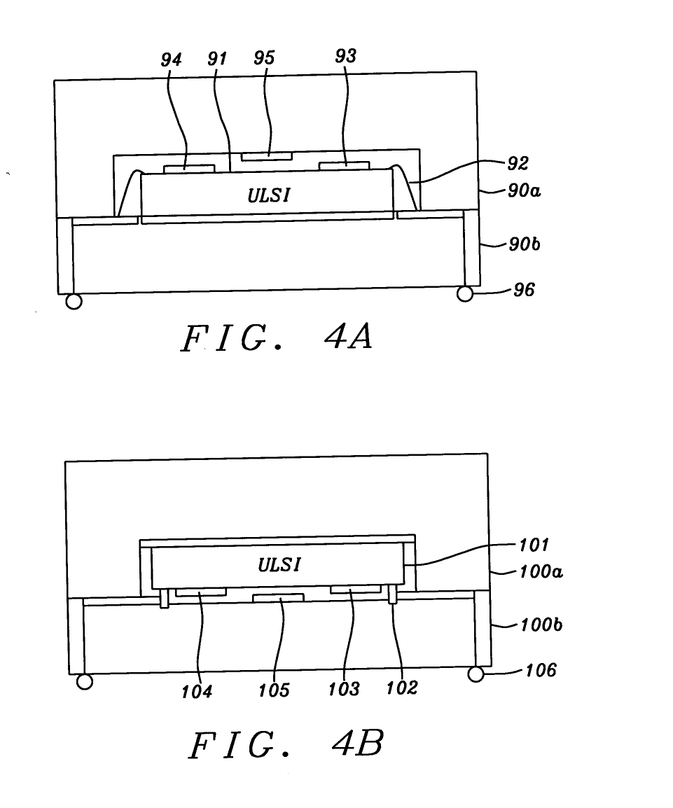

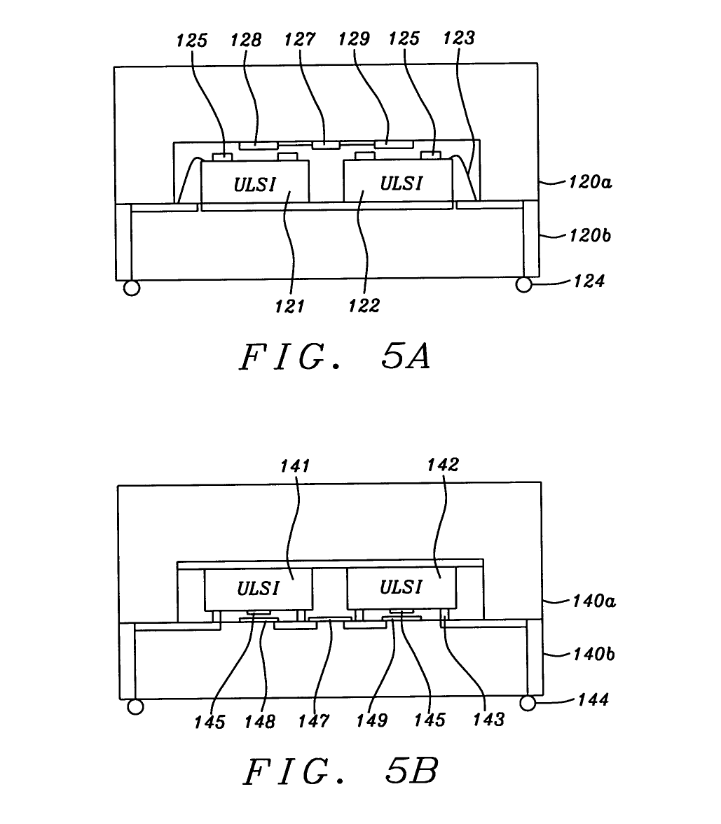

In FIG. 3B is shown a diagram of the present invention in which PCIe devices A 70 and B 71 communicate by a wireless PCIe coupling using a high frequency RF signal greater than 3 GHz. PCIe device A 70 and B 71 each contain a transmitter circuit 72 coupled to an antenna 74 and a receiver circuit 73 coupled to an antenna 74. The computing functions directly coupled to devices 70 and 71 can be either on the same large integrated chip as shown in FIG. 4A and 4B, or between two large integrated circuit chips located on the same module as shown in FIG. 5A and 5B.

In FIG. 4A and referring to FIG. 3B, a μ-satellite 95 containing a PCIe device 70 receives an RF signal from a first transmit and receive circuit 93 containing a PCIe device 71 located on the USLI chip 91. The μ-satellite 95 then retransmits the RF signal to a second transmit and receive circuit 94 containing a PCIe device 71. In FIG. 4B and referring to FIG. 3B, a μ-satellite 105 containing a PCIe device 70 receives an RF signal from a first transmit and receive circuit 103 containing a PCIe device 71 located on the USLI chip 101. The μ-satellite 105 then retransmits the RF signal to a second transmit and receive circuit 104 containing a PCIe device 71.

In FIG. 5A and referring to FIG. 3B, a μ-satellite 127 containing a PCIe device 70 receives an RF signal from a first transmit and receive circuit 125 containing a PCIe device 71 and located on the USLI chip 122. The μ-satellite 127 then retransmits the RF signal to a second transmit and receive circuit 125 on ULSI chip 121 containing a PCIe device 71. In FIG. 5B and referring to FIG. 3B, a μ-satellite 147 containing a PCIe device 70 receives an RF signal from a first transmit and receive circuit 145 containing a PCIe device 71 and located on the USLI chip 142. The μ-satellite 147 then retransmits the RF signal to a second transmit and receive circuit 145 on ULSI chip 141 containing a PCIe device 71.

In FIG. 4A is shown a diagram of a single chip module 90a and 90b of the present invention. An ultra large-scale integrated (ULSI) circuit chip 91 is wire bonded 92 to the module base 90b to provide electrical connection 96 to the USLI chip. Two transmit and receive circuits 93 and 94 are shown raised above the wiring surface of the ULSI chip for illustrative purposes. A μ-satellite 95 is shown mounted in the cap 90a of the single chip module. The two transmit and receive circuits 93 and 94 contain dipole antennas and communicate by sending RF signals to and receiving RF signals from the μ-satellite 95, which also contains a dipole antenna. The μ-satellite 95 is located 0.15 mm above the surface of the USLI chip and the transmit and receive circuits 93 and 94 each contain a dipole antenna for communication to the μ-satellite 95.

In FIG. 4B is shown a diagram similar to that of FIG. 4A where the USLI chip 101 is flip chip mounted to the module base 100b using solder pads 102, or other appropriate means, to connect the USLI chip 101 electrical pads 102 to the module base 100b to be connected to module I/O 106. A module cap 100a is shown enclosing the single chip module. The electrical pads 102 have been exaggerated to permit drawing of FIG. 4B to exhibit the μ-satellite 105 and the transmit and receive circuits 103 and 104, which are shown raised above the surface of the USLI chip for illustrative purposes. Similar to FIG. 4A, the μ-satellite 105 is positioned 0.15 mm from the surface of the wiring surface of the flip-chip 101. The two transmit and receive circuits 103 and 104 contain dipole antennas and communicate by sending RF signals to and receiving RF signals from the μ-satellite 105, which also contains a dipole antenna.

In FIG. 5A is shown a multi chip module comprising a module cap 120a and a module base 120b and two USLI chips 121 and 122. The USLI chips are wire bonded 123 to the module base 120b to provide electrical connections to the module I/O 124. Two transmit and receive circuits 125 are shown on the surface of each of the USLI chips 121 and 122. The transmit and receive circuits 125 are shown raised above the surface of the USLI chips for illustrative purposes and are integrated into the surface of the chips as are all other circuitry. A μ-satellite 127 is position on the cap of the module 120a and is coupled to two antennas 128 and 129. The first antenna 128 is positioned over the first USLI chip 121, and the second antenna is positioned over the second USLI chip 122. The first ULSI chip 121 communicates with the second USLI chip 122 by sending an RF signal to the antenna 128 coupled to the μ-satellite 127. The μ-satellite 127 then routes the RF signal to the antenna 129 located over the second USLI chip 122 and sends the RF signal to a receive circuit 125 containing a integrated dipole antenna. The second USLI chip 122 communicates with the first USLI chip 121 by sending an RF signal to the antenna 129 coupled to the μ-satellite 127. The μ-satellite 127 then routes the RF signal to the antenna 128 located over the first USLI chip 121 and sends the RF signal to a receive circuit 125 containing a integrated dipole antenna.

In FIG. 5B is shown a multi chip module comprising a module cap 140a and a module base 140b and two USLI chips 141 and 142. The USLI chips are flip-chip bonded 143 to the module base 140b to provide electrical connections to the module I/O 144. a transmit and receive circuit 145 is shown on the surface of each of the USLI chips 141 and 142. The transmit and receive circuits 145 are shown raised above the surface of the USLI chips for illustrative purposes and are integrated into the surface of the chips as are all other circuitry. A μ-satellite 147 is position on the base of the module 140b and is coupled to two antennas 148 and 149. The first antenna 148 is positioned under the first USLI chip 141, and the second antenna 149 is positioned under the second USLI chip 142. The first ULSI chip 141 communicates with the second USLI chip 142 by sending an RF signal to the antenna 148 coupled to the μ-satellite 147. The μ-satellite 147 then routes the RF signal to the antenna 149 located under the second USLI chip 142 and sends the RF signal to a receive circuit 145 containing a integrated dipole antenna. The second USLI chip 142 communicates with the first USLI chip 141 by sending an RF signal to the antenna 149 coupled to the μ-satellite 147. The μ-satellite 147 then routes the RF signal to the antenna 148 located under the first USLI chip 141 and sends the RF signal to a receive circuit 145 containing a integrated dipole antenna.

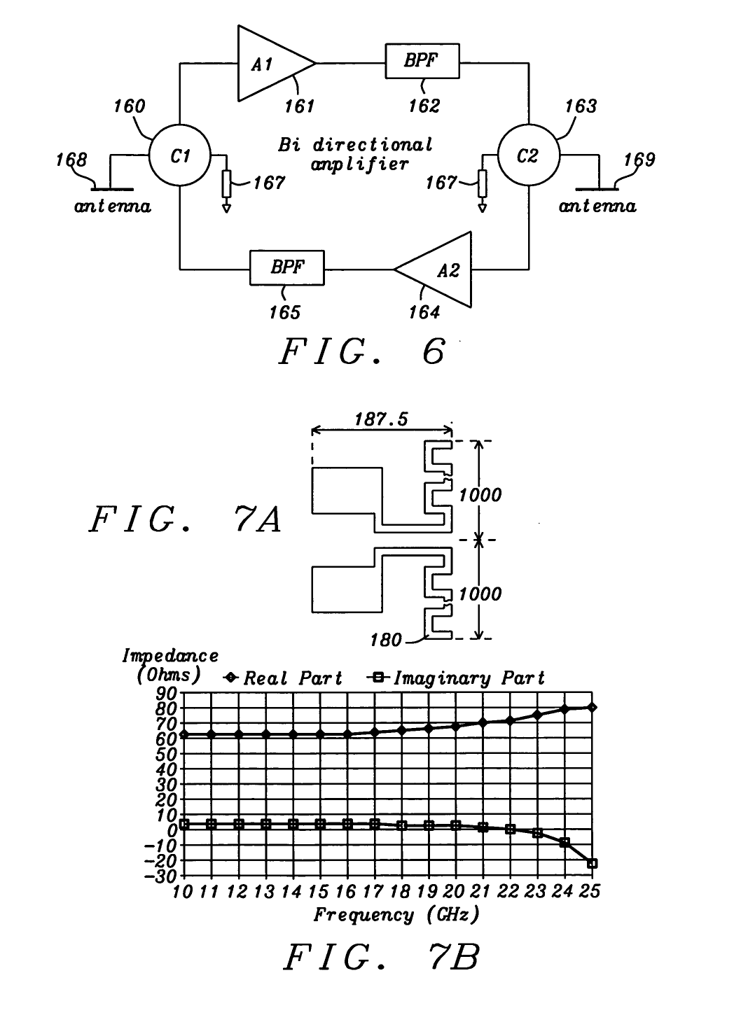

In FIG. 6 is shown a diagram of the μ-satellite of the present invention that performs in a bidirectional fashion and which comprises circulators 160 and 163, two RF amplifiers 161 and 164, and two band pass filters 162 and 165. The two circulators 160 and 163 are four port devices. The first circulator Cl 160 is connected to a first antenna 168, a first RF amplifier Al 161, a second band pass filter BPF 165 and a line terminator 167. The second circulator C2 163 is connected to a second antenna 169, a second RF amplifier A2 161, a first band pass filter BPF 162 and a line terminator 167. The RF signals are pulse position modulated and have a frequency greater than 10 GHz.

Continuing to refer to FIG. 6 and looking back at FIG. 5A and 5B, an RF signal is coupled to the first antenna 168 from a transmitter 125 or 145 on a first USLI chip 121 or 141, and is routed by the first circulator Cl 160 to the first low noise amplifier Al 161. The output of Al is coupled to the first BPF 162 and then to the second circulator C2 163. The second circulator C2 couples the RF signal to the second antenna 169, which transmits the RF signal to the receiver on the second USLI chip 122 or 142, and terminates the RF signal in a transmission line terminator 167. An RF signal is coupled to the second antenna 169 from a transmitter 125 or 145 on a first USLI chip 122 or 142, and is routed by the second circulator C2 163 to the second low noise amplifier A2 164. The output of A2 is coupled to the second BPF 165 and then to the first circulator Cl 160. The first circulator Cl couples the RF signal to the first antenna 168, which transmits the RF signal to the receiver on the first USLI chip 121 or 141, and terminates the RF signal in a transmission line terminator 167. Since the two paths in the μ-satellite are isolated from each other by separate paths and the terminated circulators 160 and 163, simultaneous transmission can take place between transmitting and receiving USLI chips 121 and 122 on the wire bonded module 120a, 120b , and between transmitting and receiving USLI chips 141 and 142 on the wire bonded module 140a, 140b.

In FIG. 7A is shown a diagram of an example of an on-chip antenna of the present invention used to transmit and receive to and from the μ-satellite. The metallization of the antenna is 4 μm thick on a layer of SiO₂ that is 20 μm thick. The dimensions shown are approximate and in units of microns. Each of the arms of the dipole antenna are approximately 1000 microns long and the width of the antenna including contact pads is approximately 187 microns. FIG. 7B shows a graphical plot of the input impedance of the antenna shown in FIG. 7A. The input impedance is relatively constant between 10 GHz and 20 GHz providing an ultra wide impedance bandwidth. It should be noted that the preferred embodiment of the antenna of the present invention is a dipole antenna shown in FIG. 7A; however, other antenna forms can be used comprising a straight dipole, a saw tooth zigzag shaped dipole, a helical antenna, a loop antenna, a slot antenna, a near field capacitive coupler antenna and an inductive coupler antenna.

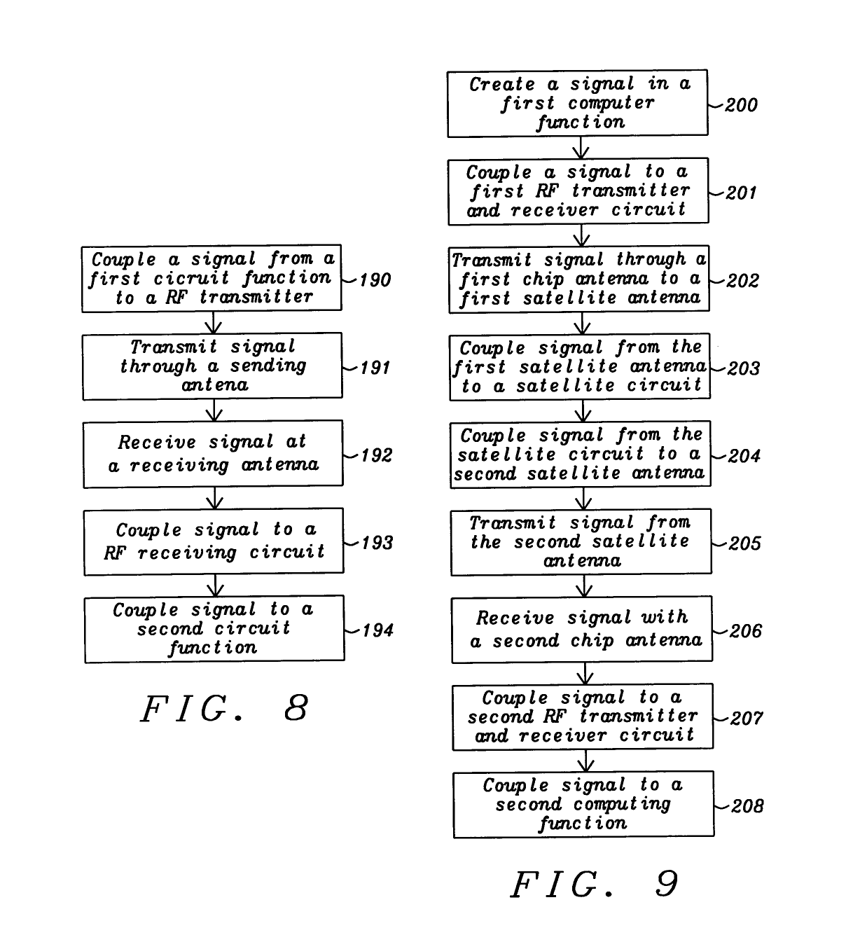

FIG. 8 shows a flow diagram of the present invention for a method communicating logical signals between functions on a same large integrated circuit chip. A logic signal is coupled from a first logic circuit function to an RF transmitter circuit 190. The logic signal can be directly coupled to a transmit-and-receive switch as shown in FIG. 2B and then coupled to the transmitting antenna 191. A transmitted signal is received at a receiving antenna located on a second logic function 192, and the transmitted signal is coupled to a receiving circuit 193. The receiving circuit, shown in FIG. 2B and using a LNA, a filter and a threshold circuit, then couples a logic signal to a second logic circuit function 194 located on the same chip as the first circuit function.

FIG. 9 shows a flow diagram of the present invention for a method to communicate using RF signals between a μ-satellite located on a module and logic functions located on one or more chips mounted on the module. The logic functions are separated by distances, which produce chip and or module wiring that limits the performance of the communications and, which limits the performance of the function being performed. A first logic function creates a logic signal to be transmitted to a second logic function 200, where the logic signal is coupled to a first RF transmitting circuit 201. The transmitting circuit creates an RF signal using a wireless PCIe circuit and transmits the RF signal through a first chip antenna to a first μ-satellite antenna 202. The first μ-satellite antenna couples the PCIe RF signal to a μ-satellite circuit 203, which amplifies and filters the PCIe RF signal and couples the PCIe RF signal to a second μ-satellite antenna 204. The second μ-satellite antenna transmits the PCIe RF signal 205 to a second chip antenna coupled to a second logic function. The second chip receives the transmitted PCIe RF signal with the second chip antenna 206, which couples the received signal to an RF receive circuit 207. The RF receive circuit demodulates the PCIe RF signal and couples the demodulated logic signal to a second computing function 207.

Continuing to refer to FIG. 9, it should be noted that wireless peripheral component interconnect express is the preferred mode for communicating digital signals between distant logical units of the present invention; however any form of modulation that can be modulated and demodulated reliably such as pulse position modulation (PPM) is within the scope of the present invention. It should further be noted that the preferred form of communicating between a chip and a remote satellite uses a high frequency radio electromagnetic signals; however any form of radiated energy signals that provide a reliable ultra wide band transmission and reception of signals such as light is within the scope of the present invention.

While the invention has been particularly shown and described with reference to preferred embodiments thereof, it will be understood by those skilled in the art that various changes in form and details may be made without departing from the spirit and scope of the invention.

1. A wireless intra-chip communication system, comprising:
a) a large integrated circuit chip,
b) a sending circuit coupled to a first logic function,
c) a receiving circuit coupled to a second logic function,
d) said first logic function couples a logic signal to an antenna of said sending circuit,
e) said antenna of the sending circuit transmits an electromagnetic signal to said receiving circuit on said integrated circuit chip to communicate data between said first logic function and said second logic function.

2. The intra-chip communication system of claim 1, wherein said first logic function is a clock and said second logic function is a clock distribution circuit local to a portion of the large integrated chip.

3. The intra-chip communication system of claim 1, wherein said electromagnetic signal is a radiated logical signal from an antenna.

4. The intra-chip communication system of claim 1, wherein said electromagnetic signal is a radio signal operating at a high frequency.

5. The intra-chip communication system of claim 4, wherein said high frequency is greater than three gigahertz.

6. The intra-chip communication system of claim 4, wherein said radio signal is formed with a wireless peripheral component interface express circuit.

7. The intra-chip communication system of claim 1, wherein said first logic function and said second logic function are separated by a physical distance on said large integrated circuit chip that limits communication performance when using interconnecting chip wiring between the first and second functions.

8. An intra chip communication system, comprising:
a) a plurality of computing functions separated by large distances on a large integrated circuit chip,
b) a plurality of radio frequency (RF) transmit and receive circuits,
c) an RF coordinator circuit,
d) said plurality of computing functions coupled to said plurality of RF transmit and receive circuits,
e) said RF coordinator communicates between said plurality of computing functions to couple an RF signal from a first computing function to a second computing function of said plurality of computing functions.

9. The intra-chip communication system of claim 8, wherein said large integrated circuit chip is an ultra large-scale integration (ULSI) chip.

10. The intra-chip communication system of claim 8, wherein said large integrated circuit chip contains a system-on-chip containing computing functions which comprise a processor, a random access memory, a non-volatile memory, control functions and I/O circuits.

11. The intra-chip communication system of claim 8, wherein said computing functions are separated by a physical distance on said large integrated circuit chip that limits communication performance when using interconnecting chip wiring.

12. The intra-chip communication system of claim 8, wherein said plurality of said RF transmit and receive circuits are each coupled to an antenna that is constructed from metallization on said large integrated circuit chip.

13. The intra-chip communication system of claim 8, wherein said RF signal is formed using a wireless peripheral component interface express (PCIe) circuit.

14. The intra-chip communication system of claim 13, wherein said transmit circuit coupled to a first computing function of said plurality of computing functions generates said RF signal from said first computing function by using a wireless PCIe circuit, and said receive circuit coupled to a second computing function of said plurality of computing functions restores said RF signal to said logic signal.

15. A wireless intra-module communication system, comprising:
a) a first send and receive circuit coupled to a first logic function on a first integrated circuit chip,
b) a second send and receive circuit coupled to a second logic function on a second integrated circuit chip,
c) a module containing a satellite device coupled to a plurality of satellite antenna,
d) said first send and receive circuit transmits an electromagnetic signal to said second send and receive circuit through said satellite device and said plurality of said satellite antenna to communicate data between said send circuit and said receive circuit.

16. The intra-module communication system of claim 15, wherein said first send and receive circuit further comprises an integrated circuit antenna to communicate to said satellite chip.

17. The intra-module communication system of claim 15, wherein said second send and receive circuit further comprises an integrated circuit antenna to communicate to said satellite device.

18. The intra-module communication system of claim 15, wherein said electromagnetic signal is a radio signal operating at a high frequency.

19. The intra-module communication system of claim 18, wherein said high frequency is greater than ten gigahertz.

20. The intra-module communication system of claim 18, wherein said radio signal is formed with a wireless peripheral component interface express circuit.

21. The intra-module communication system of claim 15, wherein said first send and receive circuit transmits a radio signal to a first satellite antenna of said plurality of satellite antennas coupled to said satellite chip and said satellite chip couples said radio signal to said second send and receive circuit through a second satellite antenna of said plurality of satellite antennas.

22. The intra-module communication system of claim 21, wherein said first and second integrated circuit chips are wire bonded to said module, said first satellite antenna is located over said first integrated circuit chip and said second satellite antenna is located over said second integrated circuit chip.

23. The intra-module communication system of claim 21, wherein said first and second integrated circuit chips are flip chip bonded to said module, said first satellite antenna is located under said first integrated circuit chip and said second satellite antenna is located under said second integrated circuit chip.

24. The intra-module communication system of claim 21, wherein said satellite chip is bidirectional, transmitting data to and from said first and second integrated circuit chips.

25. A method for communicating between circuits on a large integrated circuit chip using radio waves, comprising:
a) coupling a signal from a first circuit function to a radio transmitter circuit on a large integrated circuit chip,
b) transmitting said signal through a first antenna,
c) receiving said signal at a second antenna coupled to a radio receiver circuit,
d) coupling said signal from the radio receiver to a second circuit function on said large integrated circuit chip.

26. The method of claim 25, wherein transmitting said signal is at a frequency greater than three gigahertz.

27. The method of claim 26, wherein transmitting said signal uses wireless peripheral component interconnect express circuit.

28. The method of claim 25, wherein said first antenna is formed with metalized lines on said large integrated circuit chip.

29. The method of claim 28, wherein said metalized lines are straight lines.

30. The method of claim 28, wherein said metalized lines have a zigzag shape.

31. The method of claim 25, wherein said second antenna is formed with metalized lines on said large integrated circuit chip.

32. The method of claim 31, wherein said metalized lines are straight lines.

33. The method of claim 31, wherein said metalized lines have a zigzag shape.

34. The method of claim 25, wherein said sending circuit and said receiving circuit are physically separated by a distance which restricts communication performance as a result of chip wiring length and characteristics.

35. A method for communicating between integrated circuit chips on a module, comprising:
a) coupling a signal from a first integrated circuit chip on a module to a first radio transmitter and receiver circuit,
b) transmitting said signal through a first chip antenna located on said first integrated circuit chip to a first satellite antenna on said module,
c) coupling said signal from the first antenna to a satellite circuit on said module,
d) coupling said signal from said satellite circuit to a second satellite antenna.
e) transmitting said signal from said second satellite antenna to a second integrated circuit chip,
f) receiving said signal with a second chip antenna located on said second integrated circuit chip,
g) coupling said signal from said second antenna to a second radio transmitter and receiver circuit located on said second integrated circuit chip.

36. The method of claim 35, wherein said transmitting said signal uses a wireless peripheral interconnect express circuit.

37. The method of claim 35, wherein said first chip antenna and said second chip antenna are an irregular shape formed using metallization on said first and second integrated circuit chip.

38. The method of claim 35, wherein said satellite circuit is a bidirectional circuit.

39. The method of claim 35, wherein said first and second integrated chips are wire bonded to said module, said first satellite antenna is located over said first chip, and said second satellite antenna is located over said second chip.

40. The method of claim 39, wherein said first satellite antenna is at a distance from said first integrated circuit chip which promotes electromagnetic wave coupling as apposed to capacitive coupling.

41. The method of claim 35, wherein said first and second integrated chips are flip-chip bonded to said module, said first satellite antenna is located under said first chip, and said second satellite antenna is located under said second chip.

42. The method of claim 41, wherein said second satellite antenna is at a distance from said second integrated circuit chip which promotes electromagnetic wave coupling as apposed to capacitive coupling.

43. A communication system within a large integrated circuit chip, comprising:
a) a means for coupling logic signals from a first logic function to a transmitter circuit,
b) a means for transmitting an electromagnetic signal on an integrated circuit chip,
c) a means for receiving said electromagnetic signal on said integrated circuit chip,
d) a means for converting said electromagnetic signal to said logic signals and coupling said logic signals to a second logic function on said integrated circuit chip.

44. The system of claim 43, wherein said integrated circuit chip is a ultra large scale integrated circuit (ULSI) chip.

45. The system of claim 43, wherein said means for coupling logic signals from a first logic function to said transmitter circuit is by a direct connection to an integrated circuit antenna.

46. The system of claim 43, wherein said means for coupling logic signals from a first logic function to said transmitter circuit is through a pulse position modulator circuit.

47. The system of claim 43, wherein said means for transmitting said electromagnetic signal is an antenna.

48. The system of claim 47, wherein said antenna is a dipole antenna formed by metallization of said integrated circuit chip.

49. The system of claim 43, wherein said means for receiving said electromagnetic signal further comprises an antenna coupled to low noise amplifier.

50. The system of claim 43, wherein said means for converting said electromagnetic signal to said logic signals comprises a filter and a threshold circuit.

51. The system of claim 43, wherein said means for converting said electromagnetic signal to said logic signals comprises a wireless peripheral interconnect express circuit.

52. A communication system for communicating logic signals within a module, comprising:
a) a means for coupling logic signals from a first logic function on an integrated circuit chip contained on a module to a transmitter circuit,
b) a means for transmitting an electromagnetic signal to a satellite device contained within said module,
c) a means for receiving said electromagnetic signal at said satellite device located on said module,
d) a means for transmitting said electromagnetic signal from said satellite device,
e) a means for receiving said electromagnetic signal on said integrated circuit chip,
f) a means for coupling said electromagnetic signal to a second logic function.

53. The system of claim 52, wherein said integrated circuit chip is ultra large scale integration (USLI) chip.

54. The system of claim 52, wherein said means for coupling logic signals from a first logic function to a transmitter circuit further comprises a wireless peripheral interconnect express circuit.

55. The system of claim 52, wherein said means for transmitting an electromagnetic signal to said satellite device comprises an antenna formed with metallization on said integrated circuit chip.

56. The system of claim 52, wherein said means for receiving said electro magnetic signal at said satellite device is an antenna coupled to said satellite device and located on said module adjacent to a wiring surface of said integrated circuit chip.

57. The system of claim 52, wherein said means for transmitting said electromagnetic signal from said satellite device further comprises an RF amplifier coupled to a band pass filter which drives a four port circulator coupled to an antenna located adjacent to a wiring surface of said integrated chip.

58. The system of claim 57, wherein said satellite device is bidirectional.

59. The system of claim 52, wherein said means for receiving said electromagnetic signal on said integrated circuit chip comprises an antenna formed with metallization on said integrated circuit chip.

60. The system of claim 52, wherein said means for coupling said electromagnetic signal to said second logic function comprises a wireless peripheral interconnect express circuit.

61. The system of claim 52, further comprises a multi-chip module wherein said first logic function is located on a first chip of said multi-chip module and said second logic function is located on a second chip of said multi-chip module.

62. The system of claim 61, wherein the means for receiving said electromagnetic signal at said satellite device is an antenna located on said module adjacent to a wiring surface of said first chip.

63. The system of claim 61, wherein the means for transmitting said electromagnetic signal from said satellite device is an antenna located on said module adjacent to a wiring surface of said second chip.
